(19) United States
(12) Patent Application Publication
(10) Pub. No.: US 2024/0399669 A1
(43) Pub. Date: Dec. 5, 2024

(54) WELDING MACHINE AND METHOD FOR PRODUCING A BUTT-WELDED JOINT

(71) Applicant: Huerner Schweisstechnik GmbH, Muecke (DE)

(72) Inventors: Michael Lenz, Muecke (DE); Albert Lueghamer, Sieming (AT); Florian Kraus, Muecke (DE)

(73) Assignee: Huerner Schweisstechnik GmbH, Muecke (DE)

(21) Appl. No.: 18/699,742

(22) PCT Filed: Oct. 14, 2021
(86) PCT No.: PCT/EP2021/078448

§ 371 Date: Apr. 9, 2024

(51) Int. Cl. B29C 65/14; B29C 65/00; B29C 65/20; B29C 65/78

(52) U.S. Cl. CPC B29C 65/1432; B29C 65/20; B29C 65/7841; B29C 66/1142; B29C 66/963

(57) ABSTRACT

The invention relates to a method for producing a butt-welded joint between tube segments of a tube made of a weldable plastic material using a welding machine and to a welding machine (10), two tube segments each being held by a clamping apparatus (11) of a welding device (21) of the welding machine, welding contact surfaces of tube end cross sections of the tube segments being fused by means of a heating element (22) of the welding device and the welding contact surfaces subsequently being pressed against each other by a handling apparatus (18) of the welding device using a joining pressure to form a butt-welded seam connecting the tube segments to each other in a joining plane, the welding device being controlled by a control device of the welding machine, a data model of a tube system having at least one tube and a plurality of butt-welded joints being stored in the control device of the welding device, the data model comprising at least one object dataset representing the corresponding butt-welded joint and each having attributes, the control device detecting at least one weld parameter of the welding device as another attribute for the corresponding butt-welded joint and adding this weld parameter to the object dataset.

The invention relates to a method for producing a butt-welded joint between tube segments of a tube made of a weldable plastic material using a welding machine and to a welding machine, two tube segments each being held by a clamping apparatus of a welding device of the welding machine, welding contact surfaces of tube end cross sections of the tube segments being fused by means of a heating element of the welding device and the welding contact surfaces subsequently being pressed against each other by a handling apparatus of the welding device using a joining pressure to form a butt-welded seam joining the tube segments in a joining plane, the welding device being controlled by a control device of the welding machine.

Such processes and welding machines are well known and are used for butt welding plastic pipes. In particular, two tube segments of a tube to be formed by a butt-welded joint are joined together by the butt-welded joint. The tube end cross sections of the tube segments regularly have a matching diameter and are held in a clamping apparatus with clamping tools, are fixed and aligned relative to each other. The tube end cross sections of the tube segments are then heated and plasticized by means of a heating apparatus using a heating element. Finally, the plasticized tube end cross sections are pressed against each other via a joining pressure using a handling apparatus until the butt-welded seam formed in this mannermanner has hardened. Finally, the clamping apparatus is released and the tube can be separated from the welding machine.

In principle, the method described can be carried out entirely manually using the welding machine. However, a partially automated or fully automated version can also be provided, in which the welding machine comprises a control device which at least partially controls corresponding production steps for producing the butt-welded joint via the welding machine. Such a welding machine is known from EP 3 804 965 A1.

Particularly when high-quality tube systems are to be produced, for example in the semiconductor manufacturing sector and in the production of food and pharmaceuticals, there is the problem that, regardless of a high-quality welding machine and the materials used, users of the welding machine can form a faulty or poor-quality butt-welded joint. As tube systems for these aforementioned manufacturing facilities are usually very complex, users can, for example, accidentally use the wrong tube segments. In addition, incorrect operation of the welding machine can also lead to the formation of faulty butt-welded joints.

The object of the present invention is therefore to propose a method and a welding machine for producing a butt-welded joint, which both enable a high-quality tube system to be produced easily.

This object is attained by a method having the features of claim 1 and a welding machine having the features of claim 14.

In the method according to the invention for producing a butt-welded joint between tube segments of a tube made of a weldable plastic material using a welding machine, two tube segments are each held by a clamping apparatus of a welding device of the welding machine, welding contact surfaces of tube end cross sections of the tube segments being fused by means of a heating apparatus of the welding device and the welding contact surfaces subsequently being pressed against each other by a handling apparatus of the welding device using a joining pressure to form a butt-welded seam connecting the tube segments to each other in a joining plane, the welding device being controlled by a control device of the welding machine, a data model of a tube system having at least one tube and a plurality of butt-welded joints being stored in the control device of the welding device, the data model comprising at least one object dataset representing the corresponding butt-welded joint and each having attributes, the control device detecting at least one weld parameter of the welding device as another attribute for the corresponding butt-welded joint and adding this weld parameter to the object dataset.

A tube system is understood to be at least one tube which is formed from a plurality of butt-welded joints and/or a corresponding number of tube segments. The tube system may also comprise a plurality of tubes and connections and/or branches of tubes which connect valves, containers, reactors, machines and the like. A data model of the tube system is understood to be a digital embodiment of the tube system which can be created and further processed by data processing means, such as a computer. Since the data model of the tube system is stored in the control device as part of the method according to the invention, the control device is also designed to process digital data and can therefore be a computer, for example. The data model of the tube system comprises object datasets, each of which represents butt-welded joints to be formed using the welding machine. By storing the data model of the tube system in the control device, it can be thus ensured that essential data describing a butt-welded joint is already available in the control device. The respective object datasets in turn include attributes having the essential information on the butt-welded joint to be produced, for example information on the type of the tube segments in question. Possible errors by users when transferring data from planning documents of the tube system to a welding machine and/or control device can thus be avoided, as the information and/or data required to form the butt-welded joint is already stored for the users in the welding machine.

According to the invention, it is furthermore provided that the control device determines at least one weld parameter, such as a temperature, for the butt-welded joints in question. The weld parameter can be detected by sensors of the welding device and/or also by a computation of the control device by means of an algorithm. The relevant weld parameter is added to the associated object dataset in the form of a further attribute of the butt-welded joint. The control device can add the detected additional attribute to the respective object dataset and save it as part of the data model. In this manner, traceable documentation of the production of the tube system can be created. This also enables traceable verification of compliance with production specifications.

The data model can be stored in a storage apparatus of the control device before the butt-welded joint is formed. The control device therefore has the storage apparatus. In principle, the storage apparatus can be any type of data carrier suitable for storing data or files. Several data models of tube systems can also be stored in the storage apparatus. The storage apparatus can also be a data carrier which can be adapted to the welding machine.

The control device can detect the at least one weld parameter of the welding device as the other attribute before, while and/or after producing the corresponding butt-welded joint, the weld parameter being able to be a joining pressure, a heating-element temperature, a device temperature, an ambient temperature, at point of production time, a weld time and/or a cooling time. The control device can use the attributes contained in the object dataset even before the butt-welded joint is formed to compute the other attribute, for example a wall thickness of the tube segments to detect the required heating-element temperature. The welding device can also have one or a number of sensors with which the control device can record measured values as the further attribute, for example an ambient temperature, during the formation of the butt-welded joint. After the butt-welded joint has been formed, the control device can also process the attributes and/or measured values contained in the object dataset in order to detect the further attribute, for example a wall thickness of the tube segments in conjunction with an ambient temperature to determine a required cooling time. On the one hand, this makes it possible to compute the required weld parameters beforehand on the basis of the attributes contained in the object dataset and, on the other hand, to measure and/or verify these weld parameters during and after the formation of the butt-welded joint.

The control device can control the welding device as a function of the attributes of the object dataset, the attributes being able to be a tube segment diameter, a tube wall thickness, a plastic material, a point of fabrication time, a producer's designation, an article number and/or a serial number. Certain functions of the welding device can be linked to these attributes, for example a heating-element temperature depending on the plastic material used. It is also possible to derive the plastic material used from an article number and a producer's designation if the plastic material is not contained as an attribute in the object dataset. In principle, however, it is also possible to use these attributes to trace the production process of the butt-welded joint back to the production of the tube segments used.

Instructions for the welding machine addressed to a user and the data model can be output by means of a display apparatus of the control device. The display apparatus can be formed by one or more display means. The instructions can be signaled in acoustic and/or optical form, for example via light signals, a graphic display and/or instructions in text form. The instructions can, for example, prompt equipping the welding machine with tube segments of a certain type or an initiation of certain functions of the welding machine, such as the welding process itself. In principle, it is also conceivable that the welding machine performs some or all functions semi-automatically or fully automatically. It is also intended that the welding machine outputs the data model. This output can be executed by displaying a list with object datasets or by a graphical representation of the tube system to be created using the display device.

The display apparatus can be formed by one or more screens, the instructions being able to be displayed in a first display area and the data model having the object datasets and the corresponding attributes being able to be displayed in a second display area. The screens can be touch-sensitive screens so that users can interact with the control device, for example by acknowledging an instruction. Owing to the second display area for the data model, it is no longer necessary for users to carry out a comparison with planning documents of the tube system. The data model can then include planning documents which are stored in the control device. When operating the welding machine, a user can first select a butt-welded joint to be produced from the data model, which can be displayed in the form of a graphical, two- or three-dimensional representation of the tube system in the second display area. The attributes contained in the object datasets can then be used by the control device to display instructions in the first display area, for example information on the tube segments to be inserted into the clamping apparatus. After the butt-welded joint has been formed, the at least one further attribute can be added to the object dataset in the data model. For example, the butt-welded joint in question can then be displayed as fully welded in the second display area. Accidental repeated production of the butt-welded joint can thus be reliably precluded.

An adhesive label having a rendering of the corresponding object dataset of the butt-welded joint and/or having a rendering of a code representing this object dataset can be output by means of printer, which can be connected to the control device or can have the control device, after the butt-welded joint has been produced. The printer can be formed by an adhesive label printer which is integrated in the welding machine or is connected to the welding machine via an interface. At least one adhesive label, which has at least one object dataset relating to the butt-welded joint, can then be printed for each butt-welded joint. The object dataset can already include the other attribute, for example a production date of the butt-welded joint. A user can then apply the adhesive label to one of the tube segments, making essential information about the butt-welded joint immediately recognizable. The object dataset can be rendered on the adhesive label in text or character form. Alternatively or additionally, the adhesive label can have a code with which information about the butt-welded joint can be detected. This can be a barcode or a QR code, for example, which can be scanned with a mobile device.

A data model can be used having graphic image data and/or vector data of the tube system which are supplemented by the object dataset. The graphic image data or vector data can be in two-dimensional or three-dimensional form. Advantageously, CAD data or other known graphic data formats can contain the object datasets or be linked thereto. The graphical rendering of the tube system makes it possible to dispense with planning documents in paper form when producing the butt-welded joint.

A data model having the tube segment and/or the butt-welded joint can be used as an object having an associated object dataset. Each of the tube segments and/or the butt-welded joint can therefore be defined as an object in the data model. An object dataset can be assigned to each of these objects. All components of the tube system and their butt-welded joints can then be clearly recorded in the data model.

The data model can be used having a parts list of the tube system. The data model can be stored in the form of a parts list in the control device and be displayed according to a user. The tube segments to be welded can then be gathered from the parts list with all the necessary information and/or attributes of the butt-welded joint to be produced. In addition to the representation of a parts list, a graphical representation of the data model of the tube system can be intended.

Advantageously, the method can be executed in a sequence of the following steps:
a) generating the data model of the tube system having at least one tube and a plurality of butt-welded joints.
b) transferring and storing the data model in the control device.
c) selecting the butt-welded joint to be welded.
d) computing the weld parameter of the welding device via the control device based on the attributes of the corresponding object dataset.
e) outputting a sequence of instructions for the welding machine addressed to a user.
f) controlling the welding device via the control device for executing the production steps.
g) detecting the other attributes via the control device and storing them in the corresponding object dataset.
h) outputting and/or transferring the corresponding object dataset or the data model via the control device.

Tube end cross sections of the tube segments can be machined using a tool of the welding device to form welding contact surfaces. The tool for machining the welding contact surfaces can therefore be disposed in a stationary position. The tool can also make a separating cut to form the tube segments, the separating cut also being able to be used to form the welding contact surfaces. Consequently, the tube segments are then formed from a semi-finished product by the tool. However, the tool device can also process the tube segments on their welding contact surfaces after they have been clamped in the clamping apparatus so that they can abut against each other in the joining plane without a gap.

Furthermore, the data model can also be transferred via the control device using an external data network. The data model can be transferred reciprocally, for example from a computer to the control device and after a change to the data model by adding further attributes in the control device by saving it on the computer. The external data network can comprise at least one computer and a connection between the control device and the computer. The connection can also be wireless using a data line or a known radio standard. Optionally, it is also possible that the data model is only partially stored in the control device and is only completely available on a computer of the external data network. In this case, data can be exchanged continuously between the control device and the computer and/or server. In particular, it is then also possible to provide information about the progress of production and any planning changes to the tube system to the persons involved in production and planning in real time.

The welding machine according to the invention serves to produce a butt-welded joint between tube segments of a tube made of a weldable plastic material, the welding machine having a welding device, a clamping apparatus for holding two tube segments in each instance, a heating element for fusing welding contact surfaces of tube end cross sections of the tube segments, and a handling apparatus for the subsequent production of a butt-welded seam connecting the tube segments to each other in a connecting plane by pressing the welding contact surfaces against each other using a joining pressure, the welding device being controllable via a control device of the welding machine, a data model of a tube system having at least one tube and a plurality of butt-welded joints being stored in the control device of the welding device, the data model comprising at least one object dataset representing the corresponding butt-welded joint and each having attributes, the control device detecting at least one weld parameter of the welding device as another attribute for the corresponding butt-welded joint and adding this weld parameter to the object dataset. With regard to the advantages of the welding machine according to the invention, reference is made to the description of advantages of the method according to the invention.

Further advantageous embodiments of a welding machine are derived from the descriptions of features of the dependent claims referring to method claim 1.

In the following, a preferred embodiment of the method along with an illustration of a preferred embodiment of a welding machine for carrying out the method is explained in more detail with reference to the drawings.

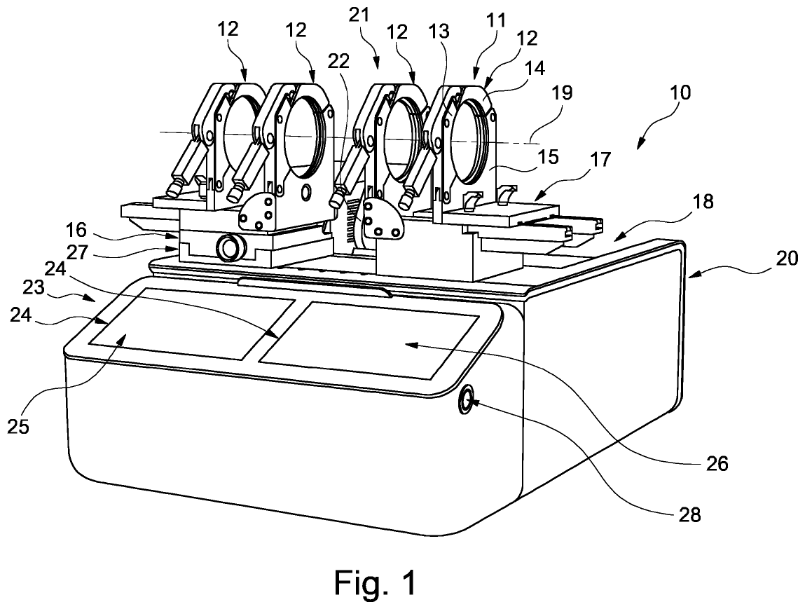

FIG. 1 shows a perspective view of a welding machine;

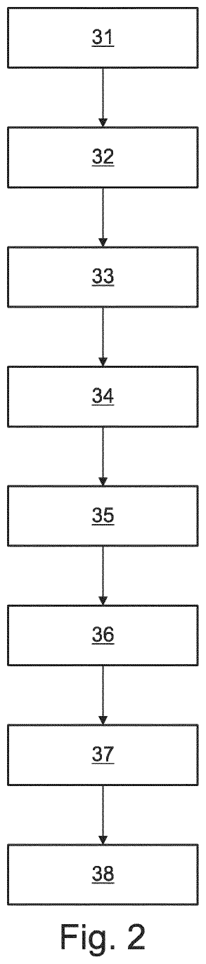

FIG. 2 shows a flow chart for a method of producing a butt-welded joint.

FIG. 1 shows a welding machine 10 for producing a butt-welded joint between two tube segments (not shown) of a tube. A welding device 21 of the welding machine 10 comprises a clamping apparatus 11 having four clamping receptacles 12, which in turn are formed from clamping jaws 13, 14 and 15. In each case, two of the clamping receptacles 12 are arranged on slides 16 and 17 of a handling apparatus 18 of the welding device 21. The slides 16 and 17 can be moved relative to each other along a longitudinal axis 19 of a tube to be produced by means of the handling apparatus 18. For this purpose, the slides 16 and 17 are disposed on a frame 20 of the welding machine 10, which forms a guide (not shown) for the slides 16 and 17. A drive for the handling apparatus 18 is also disposed within the frame 20. Furthermore, the welding device 21 comprises a heating plate 22. A user unit 23 of the welding machine 10 is disposed on the frame 20 and has two screens 24, which in turn form a first display area 25 and a second display area 26.

During a welding process, a user first clamps the tube segments to two clamping receptacles 12 of the respective slides 16 and 17 using the clamping jaws 13, 14 and 15. Then, if necessary, the tube segments are aligned relative to each other in relation to the longitudinal axis 19. A transverse guide 27 is formed on the slide 16 for this purpose. After a possible machining of the welding contact surfaces of the tube segments, the heating plate 22 is disposed between the welding contact surfaces so that the tube end cross sections of the tube segments are melted by means of the heating plate. The heating plate is then removed and the tube segments are pressed against each other by means of the slides 16 and 17 using a joining pressure, forming a butt-welded seam. Finally, the tube formed in this manner can be removed from the clamping receptacle 12. The welding machine 10 is operated by a user by means of the screens 24 and operating elements 28 on the user unit 23, among other things. A control device (not shown) of the welding machine 10 controls in particular a sequence of the welding process and the associated functions of the welding machine 10.

FIG. 2 shows a flow chart for carrying out the method using the example of the welding machine 10 shown in FIG. 1. In a first step 30, a data model of a tube system to be produced using the welding machine 10 is first generated. The data model can, for example, be designed on a computer and stored on the computer in the form of graphical image data or vector data. The data model is then generated independently of the welding machine 10. In a second step 32, the data model is transferred to the welding machine 10 and stored in the control device. This transfer can be carried out using a data carrier, a data line or a radio standard for data transmission. In a third step 33, the data model is displayed in the second display area 26 in the form of a graphical representation or a list from the control device. A user is now able to select a butt-welded joint to be welded to produce the tube system at the second display area 26. In the case of the welding machine 10 shown here, this selection can be made by the user touching the representation of the butt-welded joint in the second display area 26.

In a fourth step 34, the control device now computes the weld parameters of the welding device 21 required to form the butt-welded joint. To do this, the control device uses object datasets which have attributes, are contained in the data model and are assigned to the butt-welded joint to be formed. The attributes can, for example, include information on a tube wall thickness and a plastic material. The control device can now compute weld parameters of the welding device 21, such as a joining pressure and a cooling time, based on these attributes. In a fifth step 35, a sequence of instructions for the welding machine 10 is displayed in the first display area 25. For example, this can be information on the tube segments to be inserted in the clamping apparatus 11. It may be provided that the user in question acknowledges the instructions by touching the first display area 25 at the appropriate point, for example after the tube segments have been inserted and clamped. In a sixth step 36, the control device controls the welding device 21 so that, as described above, the butt-welded joint is formed. In a seventh step 37, the control device detects a further attribute before or during the production of the butt-welded joint, for example the further attribute can be a weld parameters computed by the control device or also a value measured by a sensor, such as an ambient temperature. This further attribute is stored by the control device in the object dataset associated with the butt-welded joint. In the simplest embodiment, the other attribute can only contain the information that the butt-welded joint has been finished.

Once the butt-welded joint has been formed, the user can remove the thus formed tube from the clamping receptacle 12. For this purpose, instructions can be displayed in the first display area 25. In an eighth step 38, the respective object dataset or the data model is output or transferred by the control device. Thus, as in step 32, the data model supplemented by attributes can then be transferred to a computer in the reverse direction and stored there.

1. A method for producing a butt-welded joint between tube segments of a tube made of a weldable plastic material using a welding machine (10), two tube segments each being held by a clamping apparatus (11) of a welding device (21) of the welding machine, welding contact surfaces of tube end cross sections of the tube segments being fused by means of a heating apparatus (22) of the welding device and the welding contact surfaces subsequently being pressed against each other by a handling apparatus (18) of the welding device using a joining pressure to form a butt-welded seam connecting the tube segments to each other in a joining plane, the welding device being controlled by a control device of the welding machine,
characterized in that
a data model of a tube system having at least one tube and a plurality of butt-welded joints are stored in the control device of the welding device, the data model comprising at least one object dataset representing the corresponding butt-welded joint and each having attributes, the control device detecting at least one weld parameter of the welding device as another attribute for the corresponding butt-welded joint and adding this weld parameter to the object dataset.

2. The method according to claim 1,
characterized in that
the data model is stored in a storage apparatus of the control device before producing the butt-welded joint.

3. The method according to claim 1,
characterized in that
the control device detects the at least one weld parameter of the welding device (21) as the other attribute before, while and/or after producing the corresponding butt-welded joint, the weld parameter being a joining pressure, a heating-element temperature, a device temperature, an ambient temperature, at point of production time, a weld time and/or a cooling time.

4. The method according to claim 1,
characterized in that
the control device controls the welding device (21) as a function of the attributes of the object dataset, the attributes being a tube segment diameter, a tube wall thickness, a plastic material, a point of fabrication time, a producer's designation, an article number and/or a serial number.

5. The method according to claim 1,
characterized in that
instructions for the welding machine (10) addressed to a user and the data model are output by means of a display apparatus of the control device.

6. The method according to claim 5,
characterized in that
the display apparatus is formed by one or more screens (24), the instructions being displayed in a first display area (25) and the data model having the object datasets and the corresponding attributes being displayed in a second display area (26).

7. The method according to claim 1,
characterized in that
an adhesive label having a rendering of the corresponding object dataset of the butt-welded joint and/or having a rendering of a code representing this object dataset is output by means of printer, which is connected to the control device or has the control device, after the butt-welded joint has been produced.

8. The method according to claim 1,
characterized in that
a data model is used having graphic image data and/or vector data of the tube system which are supplemented by the object dataset.

9. The method according to claim 1,
characterized in that
a data model having the tube segment and/or the butt-welded joint is used as an object having an associated object dataset.

10. The method according to claim 1,
characterized in that
a data model is used having a parts list of the tube system.

11. The method according to claim 1,
characterized in that
the method is executed in a sequence of the following steps:
a) generating the data model of the tube system having at least one tube and a plurality of butt-welded joints;
b) transferring and storing the data model in the control device.
c) selecting the butt-welded joint to be welded;
d) computing the weld parameter of the welding device (21) via the control device based on the attributes of the corresponding object dataset;
e) outputting a sequence of instructions for the welding machine (10) addressed to a user;
f) controlling the welding device (21) via the control device for executing the production steps;
g) detecting the other attributes via the control device and storing them in the corresponding object dataset;
h) outputting and/or transferring the corresponding object dataset or the data model via the control device.

12. The method according to claim 1,
characterized in that
tube end cross sections of the tube segments are machined using a tool of the welding device (21) to form welding contact surfaces.

13. The method according to claim 1,
characterized in that
the data model is transferred by means of the control device using an external data network.

14. A welding machine (10) for producing a butt-welded joint between tube segments of a tube made of a weldable plastic material, the welding machine having a welding device (21), a clamping apparatus (11) for holding two tube segments in each instance, a heating element (22) for fusing welding contact surfaces of tube end cross sections of the tube segments, and a handling apparatus (18) for the subsequent production of a butt-welded seam connecting the tube segments to each other in a connecting plane by pressing the welding contact surfaces against each other using a joining pressure, the welding device being controllable via a control device of the welding machine,
characterized in that
a data model of a tube system having at least one tube and a plurality of butt-welded joints is stored in the control device of the welding device, the data model comprising at least one object dataset representing the corresponding butt-welded joint and each having attributes, the control device detecting at least one weld parameter of the welding device as another attribute for the corresponding butt-welded joint and adding this weld parameter to the object dataset.

15. The method according to claim 1,
characterized in that
the data model is stored in a storage apparatus of the control device before producing the butt-welded joint;
the control device detects the at least one weld parameter of the welding device (21) as the other attribute before, while and/or after producing the corresponding butt-welded joint, the weld parameter being a joining pressure, a heating-element temperature, a device temperature, an ambient temperature, at point of production time, a weld time and/or a cooling time;
the control device controls the welding device (21) as a function of the attributes of the object dataset, the attributes being a tube segment diameter, a tube wall thickness, a plastic material, a point of fabrication time, a producer's designation, an article number and/or a serial number;
instructions for the welding machine (10) addressed to a user and the data model are output by means of a display apparatus of the control device;
the display apparatus is formed by one or more screens (24), the instructions being displayed in a first display area (25) and the data model having the object datasets and the corresponding attributes being displayed in a second display area (26);
an adhesive label having a rendering of the corresponding object dataset of the butt-welded joint and/or having a rendering of a code representing this object dataset is output by means of printer, which is connected to the control device or has the control device, after the butt-welded joint has been produced;
a data model is used having graphic image data and/or vector data of the tube system which are supplemented by the object dataset;
a data model having the tube segment and/or the butt-welded joint is used as an object having an associated object dataset;
a data model is used having a parts list of the tube system;
the method is executed in a sequence of the following steps:
a) generating the data model of the tube system having at least one tube and a plurality of butt-welded joints;
b) transferring and storing the data model in the control device;
c) selecting the butt-welded joint to be welded;
d) computing the weld parameter of the welding device (21) via the control device based on the attributes of the corresponding object dataset;
e) outputting a sequence of instructions for the welding machine (10) addressed to a user;
f) controlling the welding device (21) via the control device for executing the production steps;
g) detecting the other attributes via the control device and storing them in the corresponding object dataset;
h) outputting and/or transferring the corresponding object dataset or the data model via the control device;
tube end cross sections of the tube segments are machined using a tool of the welding device (21) to form welding contact surfaces;
the data model is transferred by means of the control device using an external data network.
